(19) United States
(12) Patent Application Publication
(10) Pub. No.: US 2013/0304620 A1
(43) Pub. Date: Nov. 14, 2013

(54) USING A VALUE-ASCERTAINABLE ITEM TO OBTAIN CREDIT AT A THIRD-PARTY MERCHANT

(71) Applicant: PLASTIC JUNGLE, INC., San Mateo, CA (US)

(72) Inventors: Ashmit Bhattacharya, Pleasanton, CA (US); Bruce Bower, Menlo Park, CA (US); Shirley Foster, Kentfield, CA (US); Steve Grove, San Jose, CA (US); Margaret Mackenzie, San Anselmo, CA (US); Daniel Rogers, Lafayette, CA (US)

(73) Assignee: Plastic Jungle, Inc., San Mateo, CA (US)

(21) Appl. No.: 13/792,811

(22) Filed: Mar. 11, 2013

Related U.S. Application Data
(63) Continuation-in-part of application No. 13/623,787, filed on Sep. 20, 2012.
(60) Provisional application No. 61/645,014, filed on May 9, 2012.

(51) Int. Cl. G06Q 40/04

(52) U.S. Cl. CPC G06Q 40/04
USPC 705/37

(57) ABSTRACT

Techniques are provided for providing value to a user in exchange for the user's value-ascertainable item. In one technique, the user, while in a merchant's store, uses a mobile device to scan a QR code that triggers a browser application to send a request to an exchange service over a network. The request includes data that is associated with the merchant. The user provides card data of a particular gift card to the exchange service. The exchange service checks the balance of the card and sends an offer for the card to the user. If the user accepts, then the exchange service sends account information and/or a bar code to the user's mobile device. The account information or bar code can be used immediately by the user to purchase one or more items at the store.

### CROSS-REFERENCE TO RELATED APPLICATION

This application claims the benefit of priority from: (1) U.S. patent application Ser. No. 13/623,787, filed Sep. 20, 2012, entitled “Digital Exchange And Mobile Wallet For Digital Currency”; which claims priority to:
(2) U.S. Provisional Application No. 61/536,881 filed Sep. 20, 2011, entitled “DIGITAL EXCHANGE AND MOBILE WALLET FOR DIGITAL CURRENCY”;
(3) U.S. Provisional Application No. 61/551,815 filed Oct. 26, 2011, entitled “DIGITAL EXCHANGE AND MOBILE WALLET FOR DIGITAL CURRENCY”; and
(4) U.S. Provisional Application No. 61/645,014 filed May 9, 2012, entitled “USING A CLOSED-LOOP STORED-VALUE INSTRUMENT AT A THIRD PARTY MERCHANT”;
   the entire contents of each of which is incorporated by this reference for all purposes as if fully disclosed herein.

This application is related to (1) U.S. application Ser. No. 12/903,987 filed Oct. 13, 2010, entitled “PROCESSING VALUE-ASCERTAINABLE ITEMS”; and (2) U.S. application Ser. No. 13/295,753 filed Nov. 14, 2011; the entire contents of each of which is incorporated by this reference for all purposes as if fully disclosed herein.

### FIELD OF THE INVENTION

The present invention relates to using value-ascertainable items, including stored-value instruments, to purchase goods or services in contexts in which the value-ascertainable items were not previously accepted as payment. More specifically, techniques are provided that allow stored-value instruments issued by one entity to be used to pay for goods or services provided by another entity that is unaffiliated with the issuer.

### BACKGROUND

Common types of financial instruments include credit cards, debit cards, and stored-value instruments. A stored-value instrument is a financial instrument, usually structured as a means for payment, in which funds are associated with the instrument and not necessarily associated with any individual. Gift and pre-paid cards are a common form of stored-value instrument. Gift cards in particular have become extremely popular in recent years. Gift cards essentially relieve the donor of the burden of selecting a specific and individually appropriate gift for the recipient, instead allowing the recipient to choose, from the range of products sold by the issuer, the actual goods or services s/he wishes upon redemption. Most gift cards resemble credit cards in size and composition, although increasingly gift cards are becoming virtualized for delivery and redemption across digital networks. Gift cards also tend to display a specific theme that corresponds to the issuer of the card. Although gift cards are typically identified by a specific number or code, gift cards are typically not associated with an individual name or account. Thus, gifts cards can be used by anybody. In order to support gift cards, an issuer of gift cards maintains (directly or indirectly) an on-line electronic system for authorization and accounting of gift cards issued by the issuer. Some gift cards can be “reloaded” with additional monetary value. Thus, the funds associated with such gift cards can be depleted and replenished multiple times.

One disadvantage of gift cards over other forms of payment is that many gift cards have an expiration date, which may vary between a few months to a few years. If the holder of a gift card does not use the gift card before the expiration date, then the issuer of the gift card may deplete or completely eliminate the associated credit from the associated card. Alternatively, due to laws in some states, the funds represented by the gift card may be claimed as “lost property” by the state in which the issuer resides or where the purchase of the gift card took place.

Another disadvantage of gift cards is that gift cards can only be used to make purchases from merchants designated by the issuers of the gift cards. Typically, the issuers of the gift cards only designate themselves. For example, a Company X's gift card can only be used at a Company X's store (whether online or in a “brick and mortar” store). The Company X's gift card cannot be used to purchase items from Company Y because Company Y does not recognize Company X's gift card as valid payment. Further, Company Y is incapable of removing any balance from Company X's gift card. In this way, gift cards are considered “closed-loop” stored-value instruments. With respect to Company X's gift card, Company Y is said to be “outside of the loop.” A closed-loop stored-value instrument (or simply “closed-loop instrument”) is typically sold by an individual retailer, serviced by the retailer (or its agents), and is accepted for purchases only at that particular retailer's locations. Another characteristic of a closed-loop instrument is that such an instrument is issued by an entity and liability is incurred by the same entity. For example, a merchant (such as Company X) issues a gift card with a positive balance and, upon issuance, incurs liability to offer goods or services in exchange for the monetary value reflected by the balance on the gift card. The gift card may only be used to purchase goods or services from that particular merchant.

Yet another disadvantage of a gift card is that, because it may be used only for goods or services offered by the issuer, a gift card recipient may not be able to fully utilize the card and put it to its best use. For example, the recipient of the gift card may not wish to purchase any of the goods or services offered by the issuer, or may have more of a need to purchase goods or services from another merchant. Or there may not be a stored location convenient to the recipient such that the card is not convenient to use. In these instances, the recipient may prefer to receive the market value for the card in cash or may prefer to deploy the market value of the card against a purchase at another merchant, rather than have the card either expire or simply go unused.

In some situations, a holding company may own multiple merchants, and allow its gift cards to be used at any of the merchants that it owns. However, even in this situation, the issuing entity and the entity that incurs the liability are the same. Consequently, even though one of the gift cards issued by the holding company may be labeled with one of its merchants and used to purchase an item from another of its merchants, such gift cards are still closed-loop instruments. With respect to gift cards issued by the holding company, the multiple merchants owned by the holding company are considered to be “inside the loop.”

In contrast, an “open-loop” instrument is an instrument that is issued by a bank or other financial institution that has a banking license. A banking license requires its holder to comply with general banking regulations to which issuers of closed-loop instruments need not comply. Open-loop instruments, unlike closed-loop instruments, also may operate over debit or credit networks, carry a network logo (e.g., Visa®), and can be used at any retail location that accepts the payment form. Common open-loop instruments include debit cards that are issued by banks and credit cards that are issued by Visa®, MasterCard®, American Express® or Discover®. When a customer with an open-loop instrument completes a purchase from a merchant using the open-loop instrument, the customer incurs liability to pay the issuing bank while the issuer of the open-loop instrument authorizes and settles against the liability.

Some instruments may be considered “semi-open” in that they may be accepted by a limited number of different merchants. An example of such an instrument is a “mall card” that is accepted by most or all merchants in a particular mall. Another example of such an instrument is a “university card” that is accepted by most or all merchants located on or around a particular university's campus. These “semi-open” instruments are considered closed-loop because the issuer is not a financial institution that is required to have a banking license and the merchants that accept the instruments are limited to those designated by the issuer of the instrument.

Based on the foregoing, what is needed is a way for a gift card holder to maximize the value of a gift card while being able to avoid some of its drawbacks.

### BRIEF DESCRIPTION OF THE DRAWINGS

FIG. 1 is a block diagram that depicts an example system architecture that supports the use of a gift card (or other value-ascertainable item) to purchase one or more items from a merchant that is “outside of the loop” with respect to the gift card, according to an embodiment;

FIG. 2 is a flow diagram that depicts a process for allowing a user to convert a value-ascertainable item (e.g., a gift card) into another form of payment, according to an embodiment;

FIG. 3 is a flow diagram that depicts a process for converting a user's third-party gift card into merchant credit that is usable at a store of the merchant, according to an embodiment;

FIGS. 4A-4E are diagrams that depict example displays that a mobile application causes to be displayed on a mobile device, according to an embodiment;

FIGS. 5A-5F are block diagrams that depict example page views that allow a user to trade in a value-ascertainable item for reward points, in an embodiment;

FIGS. 6A-6D are block diagrams that depict example page that allow a user to trade in a value-ascertainable item in order to pay a bill, in an embodiment; and

FIG. 7 is a block diagram that depicts a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0. Extending Liquidity to Value-Ascertainable Items
2.0. General Overview
3.0. System Architecture
4.0. Exchanging A Value-Ascertainable Item
   4.1 Digital Wallet
   4.2 Merchant Credit
   4.3 Transferring Account Balances
5.0. In-Store Example
   5.1 Merchant-Specific Data Flows
   5.2 Providing Information About A Value-Ascertaiable Item
      5.2.1 Using A Digital Wallet
   5.3 Determining A Value of A Value-Ascertaiable Item
   5.4 Offer For A Value-Ascertaiable Item
   5.5 Providing Merchant Credit
6.0. Online Example
7.0. Implementation Mechanism—Hardware Overviews

### 1.0 Extending Liquidity to Value-Ascertainable Items

The Internet has enabled the development of markets in select goods that have only been supported thus far by in-person, physical trade. Several techniques are described herein for extending the liquidity created by such markets into a payment means of tender. Although many examples that shall be given hereafter are in the context of closed-loop stored-value instruments (such as gift cards), the techniques described herein may be applied to any items whose values are reasonably ascertainable by an entity without the entity having the items present. Such items are referred to herein as “value-ascertainable items.”

A closed-loop stored-value instrument (such as a gift card) is merely one example of a value-ascertainable item. Other examples include baseball cards, rare coins, gems, comic books, points from a loyalty or rewards program, pre-paid cards, post-paid cards, smart cards, merchandise credit, layaways, virtual currencies, airline miles, residual insurance values, etc. A rewards program is a marketing effort that rewards and, thus encourages, loyal buying behavior, which is beneficial to the company that runs the program. For example, a retail establishment might issue loyalty or rewards cards (although not necessary) to customers who can use the cards as identification when dealing with that retailer. By presenting the card (or otherwise presenting a rewards account number), a customer may be entitled to a discount or an allotment of points that can be used for future purchases. As used herein, “value-ascertainable item” does not include traditional forms of payment, such as cash, credit cards, and debit cards.

Virtually any item may be a value-ascertainable item as long as there is an authoritative source for ascertaining the value of the item without the item itself being present. The authoritative source may be a recognized “pricing guide” for a particular type of item, or may be empirically derived. For example, the average selling price of identical items in an online auction system may be established as the authoritative source for the value of an item.

Applying the techniques described hereafter to value-ascertainable items, a cell phone may be used to purchase concert tickets and vice versa as long as the value of the cell phone and the value of the concert tickets may be ascertained to a reasonable degree of accuracy. As another example, if the value of a set of music CDs and an item of clothing may be ascertained, then that set of CDs may be used to purchase the item of clothing and vice versa.

In an embodiment, a value-ascertainable exchange service (or VAES) (similar to exchange service 120 that shall be described hereafter) hosts a website where a user (e.g., using a web browser) searches for an item and requests to pay for the item using a second item. In response, the VAES determines the value of the second item from an authoritative source. The VAES then determines an offer for the second item based on the value that the authoritative source provided for the second item. As shall be explained in greater detail hereafter in the context of closed-loop stored-value instruments, the offer value may be greater than, the same, or less than the determined value of the second item. Typically, however, the offer value will be less than the determined value of the second item. Additionally or alternatively, the VAES allows users to (1) trade in their value-ascertainable items for cash and (2) purchase the value-ascertainable items from the VAES.

### 2.0 General Overview

In an embodiment, using a mobile device, a user trades a value-ascertainable item (trade-in item) for credit at a merchant. The trade may occur before or while the user is physically located in a store of the merchant. Through the mobile device, the user provides information about the trade-in item to an exchange service. An example of the trade-in item is a third-party gift card. The exchange service determines an amount of merchant credit to provide to the user based on the information about the trade-in item. The exchange service provides, to the user, a bar code and/or an account identifier of an account that is recognized by the merchant and that has a certain balance that the exchange service applied to the account.

### 3.0 System Architecture

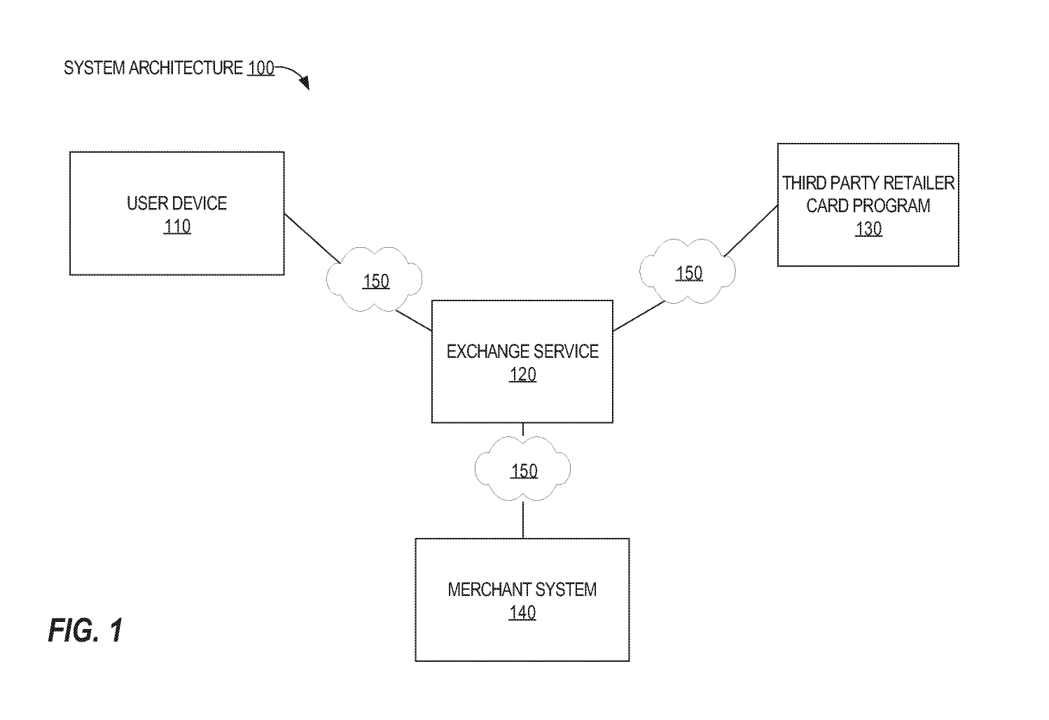

FIG. 1 is a block diagram that depicts an example system architecture 100 that supports the use of a gift card (or other value-ascertainable item) as payment to purchase one or more items from a merchant that is “outside of the loop” with respect to the gift card, according to an embodiment of the invention. FIG. 1 depicts four systems. The four systems include: (1) a card holder's user device 110; (2) an exchange service 120; (3) a third party retailer card program 130, where the third party retailer is the issuer of the gift card in question; and (4) a merchant system 140. Merchant system 140 may be operated by another party (e.g., First Data Valuelink™ or Comdata SVS™) that provides card management services to multiple merchants that issue their own gift cards.

User device 110 is not limited to any particular device. Non-limiting examples of user device 110 include a laptop computer, a tablet computer, a desktop computer, and a “smartphone”, which includes telephone capabilities.

Although exchange service 120 is depicted as a single device in FIG. 1, exchange service 120 may comprise multiple devices that operate in concert to provide an exchange service to users. In one embodiment, exchange service 120 is an entity that employs a network to facilitate the purchase and sale of closed-loop stored-value instruments and/or other value-ascertainable items (e.g., reward points).

Each of the four systems may communicate via respective networks 150. Alternatively, merchant system 140 does not communicate with exchange service 120 over a network 150, but rather over a direct link. Networks 150 may be implemented by any medium or mechanism that provides for the exchange of data between various nodes in the network. Examples of such a network include, without limitation, a network such as a Local Area Network (LAN), Wide Area Network (WAN), Ethernet, and/or the Internet, and/or one or more terrestrial, satellite, or wireless links. The network may include a combination of networks such as those described. The network may transmit data according to Transmission Control Protocol (TCP), User Datagram Protocol (UDP), and/or Internet Protocol (IP), for example.

### 4.0 Example of Exchanging a Value-Ascertainable Item

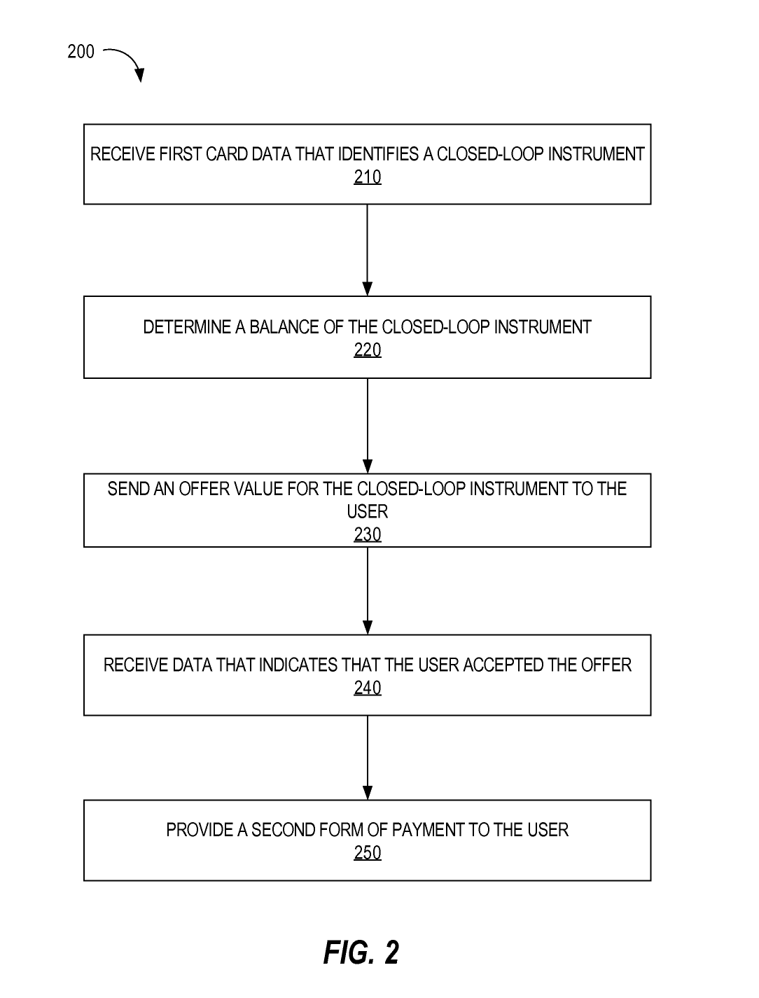

FIG. 2 is a flow diagram that depicts a process 200 for allowing a user to convert a value-ascertainable item (e.g., a gift card) into another form of payment, according to an embodiment. Process 200 may be implemented by exchange service 120 and, optionally, one or more other entities. Although only a few blocks are depicted in FIG. 2, FIG. 2 may comprise further blocks, as is described below.

At block 210, exchange service 120 receives item data that identifies or describes a value-ascertainable item that will be traded in for something else of value. Such a value-ascertainable item is referred to as a “trade-in item” or a “to-be-exchanged item.” For example, in the case of a gift card, the item data is an account number associated with the gift card. In the case of a DVD, the item data is a name of a movie or other content recorded on the DVD. The item data may be received from user device 110.

At block 220, exchange service 120 determines a value of the trade-in item. The manner in which the determination is performed depends on the type of trade-in item. For example, in the case of a gift card, exchange service 120 uses the account number of the gift card to determine the current balance of the gift card.

Determining the current balance of a closed-loop stored-value instrument may involve exchange service 120 accessing one or more web pages, one of which includes the balance. The process of automatically requesting a web page, entering data into a web form, submitting the web form, and analyzing another web page to determine a balance of a closed-loop stored-value instrument is referred to as “web scraping.” Some web sites that allow users to check balances of gift cards require CAPTCHA, where an image, movie, or audio presents a series of characters and/or one or more words that must be entered (e.g., in a text field) and validated before any balance information is displayed. In this scenario, exchange service 120 (or a component thereof) retrieves the challenge (whether visual-based or audio-based) associated with the CAPTCHA and causes the challenge to be presented to the user that owns the trade-in item. The challenge is retrieved from a web page provided by the issuer/provider of the trade-in item. The user then submits a response that exchange server 120 receives and sends to the web server that presented the CAPTCHA challenge. If the response to the CAPTCHA challenge is correct, then the web server sends, to exchange server, content that includes a current balance of the trade-in item.

Alternatively, exchange service 120 requests the balance from third party retailer card program 130, which responds to exchange service 120 with the balance. This is referred to as a “direct connection” with the issuer's card program. Thus, in an embodiment, for some closed-loop stored-value instruments, exchange service 120 uses web scraping while for other closed-loop stored-value instruments, exchange service 120 uses a direct connection to an issuer's card program.

Once the balance of a closed-loop stored-value instrument is determined, exchange service 120 determines a value of the closed-loop stored-value instrument. For example, exchange service 120 may determine that people are purchasing $100 Merchant A's gift cards for $95. This $95 value may be considered the “market value” of a $100 Merchant A's gift card. Exchange service 120 then selects a value (a “sale for” value) that is less than $95, such as $90. In this way, exchange service 120 can make a profit when exchange service 120 purchases an item for one amount and sells the item for a second amount that is greater than the first amount. Alternatively, exchange service 120 applies a static or dynamic formula to determine the value of the item, such as 90% of the balance of the gift card (if the item is a gift card) or 90% of the determined market value of the item.

As another example, in the case of reward or loyalty points, exchange service 120 uses an account number associated with the user (or authentication information of the user) to request, from the issuer of the reward points, the number or amount of reward points that the user has. Exchange service 120 determines a market value of the points, which may be $0.003 per point. Exchange service 120 then determines a value of the points based on the market value, such as $0.0025 per point, which may be used to generate an offer for the points. For example, if the user has 40,000 reward points and exchange service 120 determines that it can make a profit by purchasing the points for $0.0025 per point, then exchange service 120 may offer $100 for the 40,000 reward points.

As another example, in the case of a DVD, exchange service 120 determines a market value of the DVD based on one or more sources, which may include sources external to exchange service 120. Exchange service 120 itself may also be a source of market value information for the DVD if, for example, exchange service 120 has sold other DVDs with the same title.

At block 230, once a value of the trade-in item is determined, exchange service 120 sends, to the user, an offer that indicates the value. The data sent to user device 110 not only includes the value that user device 110 displays but also includes means to allow the user to accept or reject the offer, such as one or more graphical buttons.

At block 240, exchange service 120 receives response data that indicates that the user accepted or rejected the offer. The response data may be received from user device 110.

If the user rejected the offer, then exchange service 120 may not provide any more offers for the trade-in item owned by the user. Alternatively, exchange service 120 may generate and send another offer to the user for the trade-in item.

If the user accepted the offer, then control proceeds to block 250.

At block 250, exchange service 120 provides a second form of payment to the user. There are many possible forms of payment that exchange service 120 may provide. Examples of a second form of payment include sending cash or a check to the user. Sending a check may involve sending an online payment to the user's checking account if exchange service 120 is in possession of the necessary data to do so, such as a checking account number and a routing number.

Another example of a second form of payment is credit that is applied to a certain account of the user, such as a PayPal account, a utilities (e.g., gas and electric) account, or a credit card account. In each of these situations, exchange service 120 has access to the necessary account information and any other information necessary to automatically credit the account. Such information may be provided by the user to exchange service 120 during process 200 or some time prior to process 200.

The examples thus far of second forms of payment involve monetary-based accounts where the accounts indicate an amount in a national currency, such as dollars, euros, yen, or the yuan. Another example of a second form of payment involves crediting a non-monetary-based account, such as an account for a rewards or loyalty program. An example of such an account is one that is based on an airline program that distributes points for using the airline. Another non-monetary-based account is one that includes virtual currency. An example of virtual currency is Zeevex currency, which is a game currency that can be used to purchase virtual items in multiple online games. Embodiments of the invention are not limited to any particular type of account that is associated with a user and that may be credited.

As another example of a second form of payment that exchange service 120 provides is another value-ascertainable item, such as a digital product or a physical product. For example, exchange service 120 provides electronic equipment to a user in exchange for a gift card owned by the user.

4.1 Digital Wallet

Another example form of payment that a user in block 250 may receive is digital currency that is maintained by exchange service 120 but that is not yet converted to another form of currency. For example, exchange service 120 may provide, to the user, an electronic account that is credited each time the user has traded in or sold one or more trade-in items to exchange service 120. The electronic account is referred to herein as a “digital wallet.” A digital wallet may be viewed as a debit card account maintained by exchange service 120, although the user may not be able to pay for items with the amount reflected in the digital wallet. Instead, the balance of a digital wallet may be viewed as temporary currency that is yet to be converted into currency that is recognizable by a merchant. Thus, the user is not required to make an immediate purchase with the value of an offer, from exchange service 120, that the user accepted.

Exchange service 120 may maintain and store information about digital wallets for many users. Later, a user may redeem a portion of a balance reflected in the user's digital wallet by purchasing one or more other value-ascertainable items, such as products, services, or reward or loyalty points that are available for purchase through exchange service 120, which items exchange service 120 may have purchased from other users. Additionally or alternatively, a user may redeem a portion of a balance reflected in the user's digital wallet by instructing exchange service 120 to credit one or more accounts of the user, such as a PayPal account, a credit card account, or a telephone bill account. For example, a user may accept an offer of $90 for a $100 Macy's gift card. The user may then instruct exchange service 120 to credit the $90 to the user's PayPal account. Alternatively, the user may instruct exchange service 120 to credit one portion (e.g., $40) of the $90 to a credit card account and another portion (e.g., $50) of the $90 to an online game account that accepts virtual currency. For example, $50 may purchase 25,000 Zynga points that can be used to purchase (e.g., virtual) items in one or more games.

In an embodiment, exchange service 120 provides multiple types of payment to a user in exchange for a value-ascertainable item owned by the user. For example, exchange service 120 provides, to a user, first merchant credit (e.g., in the form of an account identifier) that is redeemable at merchant A and second merchant credit that is redeemable at merchant B in exchange for a gift card owned by the user. Similarly, the different forms of payment are for the same merchant but for different products and/or services provided by the merchant. For example, exchange service 120 may provide (1) first merchant credit that is usable to purchase movies from merchant A and (2) second merchant credit that is usable to purchase music from merchant A.

4.2 Merchant Credit

In an embodiment, a second form of payment involves providing merchant credit to the user. The merchant credit may be in the form of a gift card issued by the merchant. If the gift card is physical, then exchange service 120 causes a physical card to be mailed to the user.

Additionally or alternatively, exchange service 120 associates a value with a “new” account of the merchant. The account is “new” in that the account has a zero balance and is considered inactive. The “new” account may be identified by any set of values, such as a series of alphanumeric characters. Exchange service 120 may store a record or data that associates a “new” account with the value accepted by the user. After a “new” account is associated with a user and/or a non-zero balance, the account is considered active.

Exchange service 120 maintains a set of one or more new account identifiers that each identifies a new account. Each new account may be considered “inactive until exchange service 120 associates a balance with the new account and/or information about the new account is sent to a user that provided something of value (e.g., cash, credit card, trade-in item) in exchange for the new account. The new account identifiers may be established by the merchant or by exchange service 120 based on an agreement with the merchant. For example, the merchant may provide the new account identifiers to exchange service 120 (e.g., from merchant system 140) prior to a user requesting merchant credit from exchange service 120 in exchange for a trade-in item. Alternatively, exchange service 120 may request a new account identifier from the merchant (e.g., by interacting with merchant system 140) in response to the user requesting merchant credit.

A new merchant account may be associated with a user at one of multiple possible times. For example, a user may have a digital wallet maintained by exchange service 120 and may have converted (or redeemed) a gift card into dollar-denominated currency that the digital wallet reflects. At the time of the conversion, the user might not know what the user will purchase with the currency. Later, the user may instruct exchange service 120 to convert some of the user's currency into a credit that is redeemable at a particular merchant.

As another example, a user may request exchange service 120 to accept the user's trade-in item in exchange for credit that is usable at a particular merchant. Thus, a single transaction with exchange service 120 may involve exchange service 120 accepting a trade-in item from a user and providing merchant credit to the user as a result.

Once a new merchant account has been associated with a user, the user may use at least a portion of the value associated with the new merchant account to purchase one or more items or services from the merchant. Exchange service 120 may provide merchant credit to a user in one of multiple possible ways. For example, exchange service 120 may send a merchant account identifier to a device (e.g., via SMS) or to an email account of the user. The user may then enter the account identifier in a web browser that displays a webpage provided by the merchant. As another example, exchange service 120 may send a bar code to a mobile device of the user some time before or while the user (with his/her mobile device) is located in a store of the merchant. The mobile device displays the bar code, which can be read by a merchant bar code scanner in order to determine a balance associated with the account.

4.3 Transferring Account Balances

Over time, exchange service 120 may come to own many closed-loop stored-value instruments by purchasing those instruments from multiple users. In an embodiment, the balance of a closed-loop stored-value instrument (e.g., a gift card) issued by a particular merchant transfers wholly to another account recognized by the particular merchant. Thus, merchant credit that exchange service 120 offers may be restricted to a value that was previously associated with an account maintained by the particular merchant. For example, in the context of gift cards, a first user owns a $100 gift card issued by a particular merchant. The first user exchanges the first gift card, through exchange service 120, for something else of value, such as $85 cash or reward points for another merchant. After the exchange, exchange service 120 owns the balance associated with the first gift card while the liability reflected by the first gift card (i.e., $100) remains with the particular merchant. The first gift card is deactivated and/or the balance of the first gift card is zeroed so that the first user (or any other user) cannot use the first gift card to purchase any item from the particular merchant. Later, exchange service 120 applies the $100 to a new account recognized by the particular merchant. Exchange service 120 provides (e.g., sells) the new account with the $100 balance to a second user. The second user may have purchased the new account from exchange service 120 for cash or may have traded another value-ascertainable item for credit usable at the particular merchant. In either case, exchange service 120 instructs the particular merchant to apply the balance that was previously on the first gift card (i.e., $100) to the new account. Thus, the balances of traded-in gift cards (or other closed-loop stored-value instruments) may be transferred to an equal number of new accounts.

Alternatively, there may be no balance-to-single account restriction, as least for some issuers. For example, exchange service 120 may purchase, from four different users, four $100 gift cards issued by a particular merchant and offer (or sell), to a single user, a single new $400 gift card redeemable at the particular merchant. As another example, exchange service 120 may purchase a single $100 gift card issued by a particular merchant and offer (or sell), to each of four different users, a $25 gift card redeemable at the particular merchant.

Alternatively to deactivating an exchanged (or “purchased” gift card from the perspective of exchange service 120), exchange service 120 escrows the funds that otherwise would be paid out in order to secure the balance of the exchanged gift card. In both alternatives, the transaction is secure. In both alternatives, exchange service 120 ensures that the balance is present when an eventual buyer from exchange service 120 redeems the exchanged gift card

### 5.0 In-Store Example

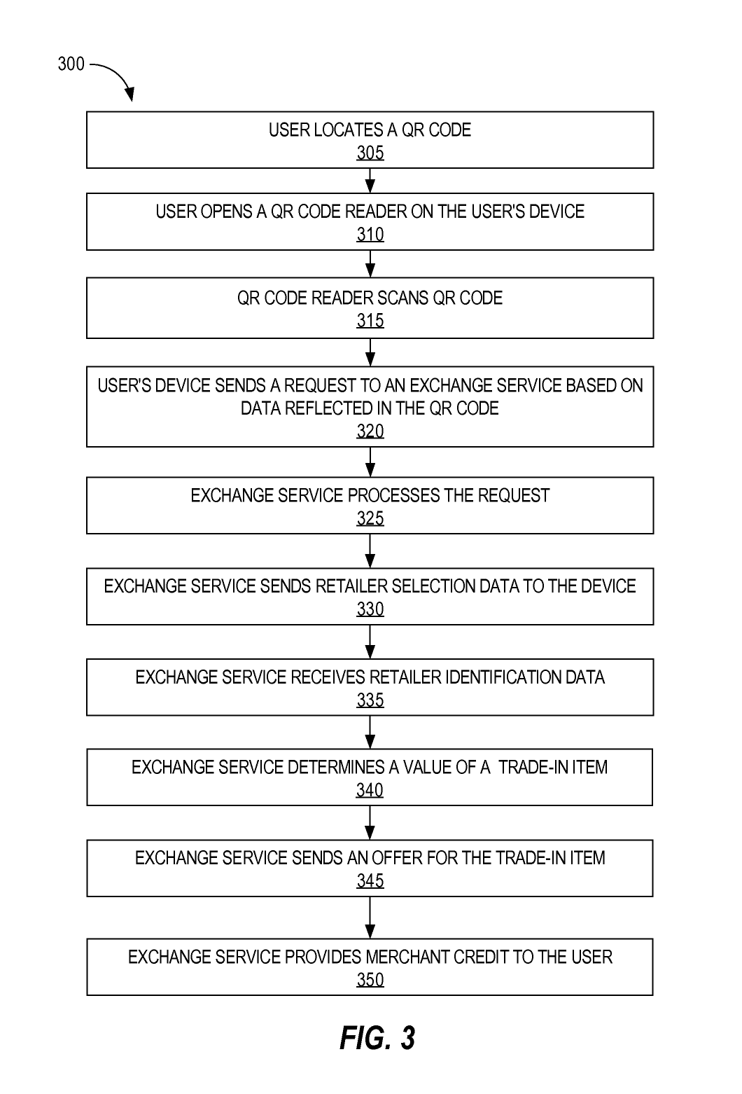

Many consumers carry gift cards in their wallets or purses while shopping. Embodiments of the invention allow those consumers to use their gift cards (or other value-ascertainable items) in a store of a merchant that did not issue the gift cards. FIG. 3 is a flow diagram that depicts a process 300 for converting a user's trade-in item (such as a third-party gift card) into merchant credit that is usable at a store of the merchant, according to an embodiment. Although process 300 is depicted as being performed in a particular order, that order is not required and may vary from one implementation to another.

A merchant store may display information that reminds or informs shoppers that they can convert third-party gift cards into merchant credit. The information may take any form. An example of such information is a QR code. A QR code is a type of two-dimensional code that comprises black modules (or dots) arranged in a square pattern on a white background. Many different types of information may be encoded in a QR code. One possible type of information is a URL (or Uniform Resource Locator). If a mobile device includes a QR reader, then the QR reader can decode a QR code into a URL and cause a browser application on the mobile device to open up request data using the URL.

In an embodiment, a merchant places a QR code in a store of the merchant to allow a user to obtain merchant credit immediately based on a trade-in item (e.g., a gift card) that is not provided (e.g., issued) by the merchant.

At block 305, a user visually locates a QR code in a store of a merchant. The merchant may place the QR code anywhere within the store or outside the store. In fact, the merchant may have a QR code placed on an advertisement in a magazine, on a billboard, or on a side of a bus. For example, the merchant may place a QR code near a checkout line in the store or near a display of gift cards.

At block 310, the user opens a QR code reader application on the user's mobile device.

At block 315, the user causes the QR code reader application to scan the QR code and determine a URL reflected in the QR code. In an embodiment, the URL includes merchant identification data that is used by exchange service 120 to identify the merchant that provided (or otherwise displays) the QR code.

At block 320, QR code reader application causes another application (e.g., a web browser) on the mobile device to request data (e.g., a HTTP request) using the URL.

Alternatively to blocks 305-320, the user may open up a web browser or other application on the user's device and cause the application to send a request to exchange service 120. In either scenario, the application that executes on the user's mobile device is referred to herein as the “mobile application.”

At block 325, exchange service 120 receives and processes the request from the mobile application (or a mobile-optimized application running in a browser). The request may indicate the merchant for which credit is sought. Before the user initiated the request, the user may have specified the merchant or selected the merchant, for example, from a plurality of possible merchants. Alternatively, the URL reflected in QR code may include data that indicates the merchant.

In an embodiment, the request does not indicate the merchant. In this embodiment, in response to receiving the request, exchange service 120 provides merchant selection data to the mobile device of the user. The mobile device application processes the merchant selection data and causes merchant display data to be displayed. The merchant display data allows the user to specify a merchant for which credit is sought.

After exchange service 120 identifies the merchant for which credit is sought by the user, process 300 proceeds to block 330. Alternatively, exchange service 120 identifies the merchant after exchange service 120 identifies the issuer or provider of the trade-in item.

5.1 Merchant-Specific Data Flows

In an embodiment, exchange service 120 maintains a plurality of merchant-specific data flows, each of which is associated with a different merchant. For example, one data flow may be associated with Merchant A while another data flow may be associated with Merchant B. A data flow dictates what exchange service 120 provides to a mobile application for display during the process of providing merchant credit to a user. A data flow comprises a set of one or more displays. Each display of a merchant-specific data flow may include information associated with the merchant for which credit is sought, such as a logo of the merchant and a certain set of colors, shapes, and text size and font typically used by the merchant. In other words, the display(s) of a merchant-specific data flow may indicate the “look and feel” of the merchant. Thus, the data flow of a particular merchant may be established by, or at least approved by, the particular merchant.

In this embodiment, after exchange service 120 identifies the merchant for which credit is sought (which identification may be based on the request received in block 325), exchange service 120 identifies a merchant-specific data flow associated with the merchant. Exchange service 120 then sends the one or more displays to the user's mobile application at the appropriate time(s). If none of the plurality of data flows maintained by exchange service 120 is associated with the merchant for which credit is sought, then exchange service 120 may select a default data flow that is not specific (e.g., in its content or style) to any particular merchant.

5.2 Providing Information about a Value-Ascertainable Item

At block 330, exchange service 120 provides retailer selection data to the mobile device of the user. The mobile application processes the retailer selection data and causes display data to be displayed. The display data allows the user specify a retailer or issuer of a trade-in item that the user owns. The display data may also allow the user to enter item data about the trade-in item, such as a description of the item, an account number of the item, a model number, or some other identifier of the item.

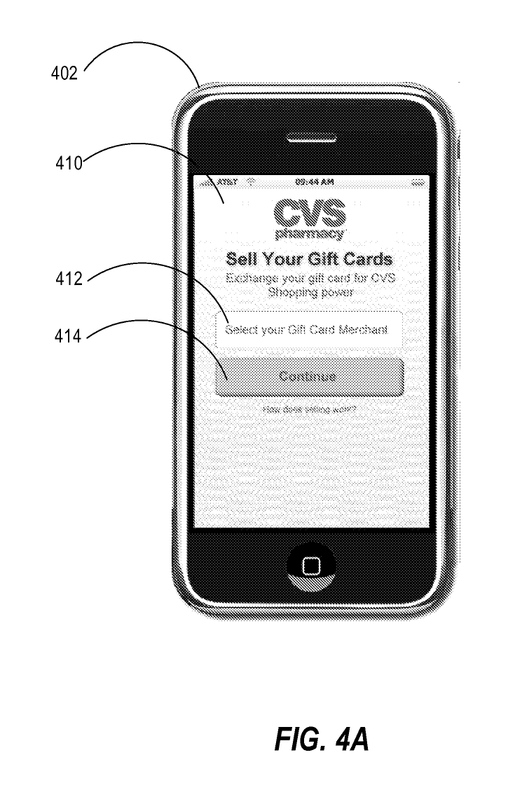

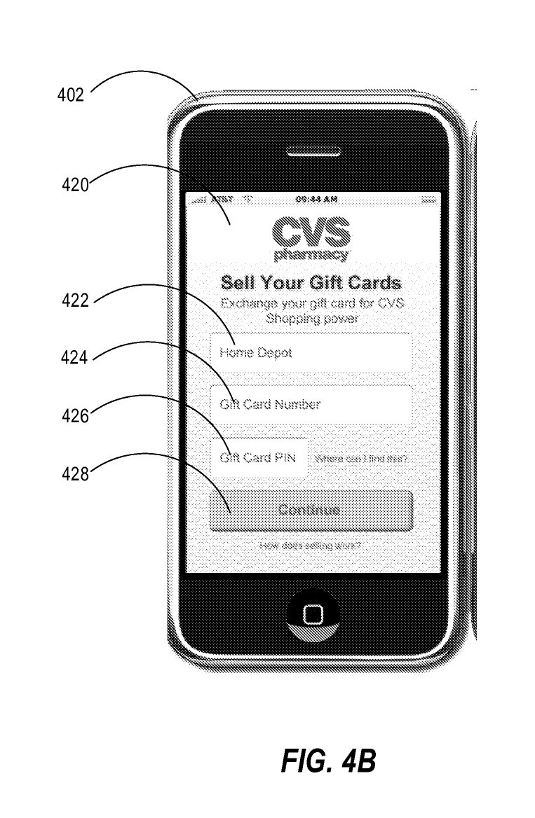

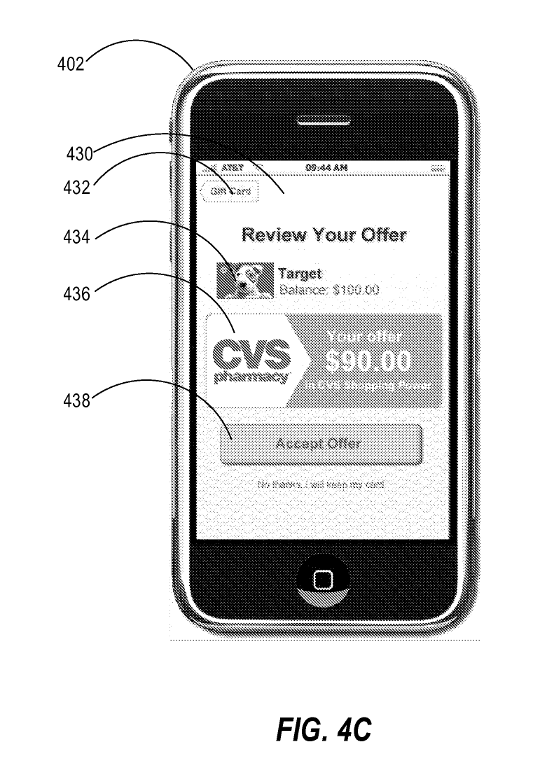

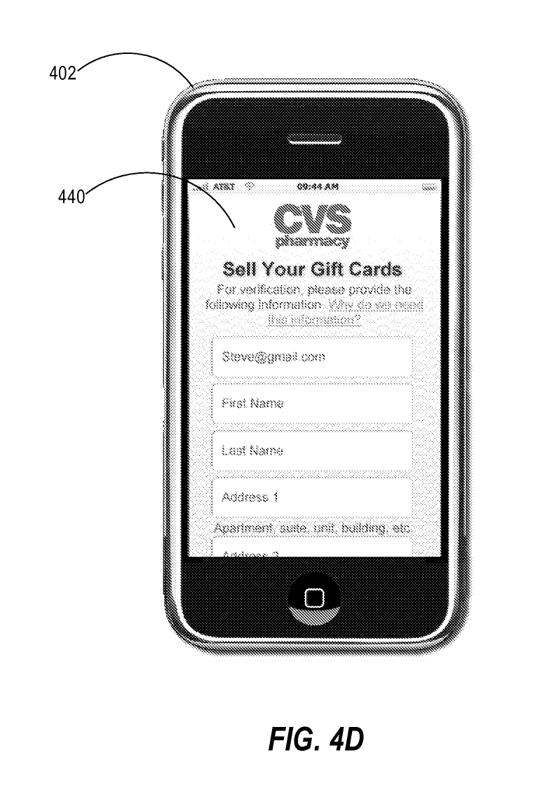

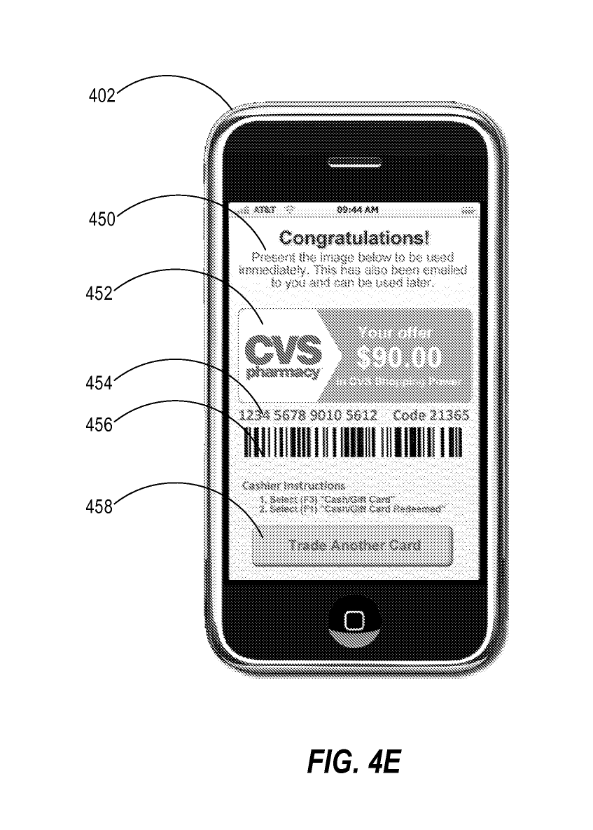

FIG. 4A is a diagram that depicts an example display 410 that a mobile application causes to be displayed on the user's mobile device 402, in an embodiment. Display 410 may be part of a merchant-specific data flow. Display 410 includes a data entry field 412 into which a user may enter, in this example, retailer identification data that identifies a merchant or issuer of a value-ascertainable item that the user is attempting to exchange. Mobile device 402 may include voice recognition capabilities to convert voice data into text data and populate data entry field 412 with the text data. Display 410 also includes a button 404 that, when selected, causes mobile device 402 to send the entered data over a network to exchange service 120.

FIG. 4B is a diagram that depicts an example display 420 that the mobile application causes to be displayed on mobile device 402, in an embodiment. Like display 410, display 420 may be part of a merchant-specific data flow. Display 420 includes fields 422-426 and button 428 that, when selected, causes mobile device 402 to send the entered data over a network to exchange service 120. Data field 422 indicates the name of the retailer or issuer of the trade-in item. Field 422 may already be filled based on the data entered into data entry field 412 of display 410. Data field 422 may be changed based on input from the user.

Data entry field 424 allows a user to enter item identification data that identifies a value-ascertainable item. In the context of gift cards, item identification data is a gift card number. Data entry field 426 allows a user to enter a PIN. The number of data fields may depend on the type of value-ascertainable item in which the user is attempting to trade. For example, some gift cards have a PIN while other gift cards and other value-ascertainable items do not.

At block 335, exchange service 120 receives item identification data from the mobile application. In the context of gift cards, an example of “item identification data” is a gift card number and, optionally, a PIN.

5.2.1 Using a Digital Wallet

In an embodiment, blocks 305-335 are performed while a user is in a store of the merchant. Thus, the user enters information about a value-ascertainable item to trade in “on-the-fly.” In an alternative embodiment, instead of the user entering information about a value-ascertainable item to trade after initiating the request of block 320, the user has already traded in one or more value-ascertainable items (i.e., prior to the current iteration of process 300). Thus, a user is not required to trade in a value-ascertainable item when the user desires merchant credit at the moment.

In this alternative embodiment, at block 330, exchange service 120 sends, to the mobile application, digital wallet data associated with the user. The digital wallet data includes data about the user's digital wallet.

The digital wallet data may indicate a single value that reflects a sum of the user-accepted values of one or more trade-in items that the user traded to exchange service 120. For example, the digital wallet data sent to the user's mobile application may indicate $252, which may be based on an $85 accepted offer for a $100 gift card, a $64 accepted offer for 2,000 loyalty points issued by a particular gas company, and a $104 accepted offer for a laptop computer. Then, at block 335, the user may instruct exchange service 120 to convert the entire amount (i.e., $252 in this example) into merchant credit at one time. Alternatively, the user may specify a different amount, such as $20, that is to be converted into merchant credit. In fact, the user may specify the exact amount of a particular checkout of one or more items from the merchant, such as $10.89.

Alternatively, instead of indicating a single value, the digital wallet data identifies multiple items, each of which corresponds to a trade-in item that the user offered to exchange service 120 and exchange service 120 accepted. For example, one item may be a gift card, another item may be reward points issued by a particular airline, and another item may be a desktop computer. Each item is associated with a value (e.g., $24) that indicates the value that the user accepted for that item. Then, at block 335, the user, using the mobile application, may select one or more of the values (or items) to convert into merchant credit. Exchange service 120 receives the selection data and proceeds to block 350.

Alternatively, the digital wallet data may already indicate one or more merchant credit items that are associated with the merchant and the user. In other words, the user may have previously traded in one or more value-ascertainable items for merchant credit. A merchant credit item may indicate a value or amount of merchant credit and an account identifier that identifies an account maintained by a merchant. For example, the digital wallet data may indicate the following merchant credit items: $113 of credit at Merchant A, 1,025 loyalty points at Merchant B, and 23,123 virtual game “bucks” at Merchant C.

If the user's digital wallet includes multiple merchant credit items for different merchants (i.e., reflecting completed trades of other trade-in item(s) for credit at those merchants), then exchange service 120 may provide only merchant credit items about the merchant involved in the current iteration of process 300. Thus, exchange service 120, upon determining the identity of the merchant (e.g., based on the request in block 325, or based on the geo-location of the user), automatically identifies one or more merchant credit items in the user's digital wallet and process 300 proceeds to block 350, where exchange service 120 provides information about the one or more merchant credit items to the user's mobile application.

5.3 Determining a Value of a Value-Ascertainable Item

At block 340, exchange service 120 uses the item identification data to determine a value of the value-ascertainable item. In the context of gift cards, block 340 may involve exchange service 120 determining a balance of a gift card identified by the item identification data.

The balance of a gift card may be determined in one of at least two ways: interacting with gift card program 130 or interacting with a (public) web server maintained by the issuer or provider of the gift card.

Once information about a value-ascertainable item (e.g., a balance in the case of a gift card) is determined, exchange service 120 determines a value for which exchange service 120 will offer for the value-ascertainable item. For example, exchange service 120 may determine that $100 gift cards issued by Company X are being purchased by others (e.g., from exchange service 120) for $95. The $95 may be considered a “market value” for $100 gift cards issued by Company X. In order to make a profit, exchange service 120 should offer less than $95 (e.g., $80, or a certain percentage of the market value) for a $100 gift card issued by Company X in which the user would like to trade.

Block 340 (or an earlier block) may involve exchange service 120 performing a fraud check to determine whether to make an offer for the value-ascertainable item and/or how much the offer will be. Example criteria that exchange service 120 uses to perform the fraud check include the identity of the maker or issuer of the value-ascertainable item (e.g., some issuers or makers of value-ascertainable items may be associated with more fraud than other issuers or makers), the type of value-ascertainable item (e.g., some types of value-ascertainable items, such as car radios, may be associated with more fraud than other types), the identity of the user (including, for example, name, address, and phone number), and information about the user (e.g., purchase history with exchange service 120, web browsing history of the user, credit card number, third-party account information, etc.). The result of a fraud check may yield a fraud score that indicates a level of risk of exchange service 120 accepting the value-ascertainable item.

Alternatively, the fraud check may be performed by a third party with which exchange service 120 contracts. In this embodiment, the third party may determine whether to even accept the value-ascertainable item based on one or more types of information described above. Alternatively, the third party provides, to exchange service 120, data (e.g., a fraud score) that is based on the one or more types of information and that exchange service 120 uses to determine whether to accept the value-ascertainable item and, optionally, what the offer value for the value-ascertainable item should be.

5.4 Offer for a Value-Ascertainable Item

At block 345, exchange service 120 sends, to the user's mobile device, an offer that indicates the value. FIG. 4C is a diagram that depicts an example display 430 that the mobile application causes to be displayed on mobile device 402, in an embodiment. Display 430 includes data elements 432-438. Data element 432 is a selectable element that, when selected, causes display 410 or display 420 to be displayed. A user may select data element 432 if the user desires to convert a different value-ascertainable item into merchant credit.

Data element 434 indicates information about the value-ascertainable item that the user desires to convert into merchant credit. In this example, the value-ascertainable item is a gift card and the balance is $100.

Data element 436 indicates information about the offer from exchange service 120, which is reflected in merchant credit. In this example, the offer is $90 of merchant credit. In an embodiment, exchange service 120 sends multiple offers for the value-ascertainable item that the user desires to exchange. The difference in offers may reflect a level of trust that exchange service 120 currently has for the user and one or more other levels of trust that exchange service 120 might have for the user. For example, exchange service 120 may provide a relatively low offer value to the user if little to no information is known about the user or if the type of value-ascertainable item (e.g., a certain brand of smartphones) is associated with a relatively significant amount of theft or fraud. A relatively high offer value may be present to the user if the user is willing to share additional information about the value-ascertainable item or the user, such as a personal address, credit card number, or PayPal account information. Thus, display 430 (or another display not depicted) may include data that invites the user to provide additional information that can be used to increase the level of trust exchange service 120 has for the user and/or for the transaction.

FIG. 4D is a diagram that depicts an example display 440 that the mobile application causes to be displayed on mobile device 402, in an embodiment. Display 440 includes data entry elements that allow a user to enter information about the user, such as the user's name, email address, and address. Other information may include the user's birthday, the user's gender, the user's income level, and the user's level of education. Display 440 may be displayed to the user before or after display 430 is displayed to the user.

Data element 438 of display 430 is a button that, when selected, causes the mobile application to send, to exchange service 120, acceptance data that indicates that the user accepted the offer, or, if multiple offers were displayed in display 430, which of the multiple offers was accepted. Display 430 may also include a data element that, when selected, causes the mobile application to send, to exchange service 120, declination data that indicates that the user declines the displayed offer.

5.5 Providing Merchant Credit

At block 350, if the user accepts the offer, then exchange service 120 provides merchant credit to the user. Block 350 may involve exchange service 120 sending, to the mobile application, credit data that indicates information about merchant credit that the user may use immediately. In an embodiment, the credit data is account identification data that identifies an (“new”) account that is maintained by the merchant and that is associated with a balance.

The balance of the account may be denominated in dollars or another national currency, or in another form of currency, such as reward points that only the merchant or only a limited number of merchants accept as a valid form of payment for goods and/or services.

The balance of the account may be the entire amount of the offer. If the balance of the account is less than the checkout balance at Merchant B after converting a value-ascertainable item from Merchant A into credit usable at Merchant B, then the account is decremented to zero. For example, a $90 in merchant credit at Merchant B is used to purchase $120 of goods or services at Merchant B. The “new” account after the purchase is zero and the user must use other forms of payment (e.g., cash, debit card, credit card, or another value-ascertainable item) to account for the $30 difference. If the balance of the account is greater than the checkout balance, then the account is decremented and a reduced balance remains in the account. The remaining balance may be used for a subsequent purchase from the merchant.

Alternatively, the balance of the account may be some other amount, such as an amount that is limited to the total amount of the checkout. For example, if the offer is $90 for a $100 gift card to Merchant A and the user is about to purchase $41.99 at Merchant B, then the balance of the “new” account of Merchant B may be $41.99. The remainder (i.e., $48.01 in this example) may be credited to a “generic” account that is maintained by exchange service 120 and whose balance is yet to be converted to credit redeemable or acceptable at any merchant.

Block 350 may involve exchange service 120 associating the accepted offer value with account identification data that identifies an account that is maintained by the merchant. The merchant may have provided the account identification data to exchange service 120 prior to the current iteration of process 300. In this way, exchange service 120 maintains a “bank” of account identifiers of “new” or “unused” accounts of a particular merchant, which “bank” exchange service 120 can rely on when providing credit of that particular merchant to users.

Alternatively, the merchant may have provided the account identification data to exchange service 120 after the current iteration of process 300 began. Thus, exchange service 120 may have requested, from the merchant, new account data in response to receiving acceptance data from the user.

FIG. 4E is a diagram that depicts an example display 450 that the mobile application causes to be displayed on mobile device 402, in an embodiment. Display 450 includes data elements 452-458. Data element 452 indicates the offer that the user accepted. Data element 454 indicates an account number of an account that is associated with the merchant credit.

Data element 456 is a bar code that reflects the account number. A bar code reader at a merchant store can scan the bar code in order to read the account number and determine a balance of the account. A bar code may come in many forms, including a series of vertical lines (1D) or geometric patterns (2D). Embodiments of the invention are not limited to any particular type or form of bar code.

Data element 458 is a button that, when selected, indicates that the user would like to trade in another value-ascertainable item for additional merchant credit. Selection of data element 458 may cause mobile application to re-display display 410, depicted in FIG. 4A.

### 6.0 Online Example

There are numerous ways in which an owner of a value-ascertainable item can leverage exchange service 120 in order to exchange her value-ascertainable item for another value-ascertainable item. In the in-store example described previously, a user might discover (while the user is in a store of a particular merchant) a way to access a web page that allows the user to trade-in the user's gift card for merchant credit. In the following example, a user discovers a trade opportunity online while viewing content provided by a particular merchant.

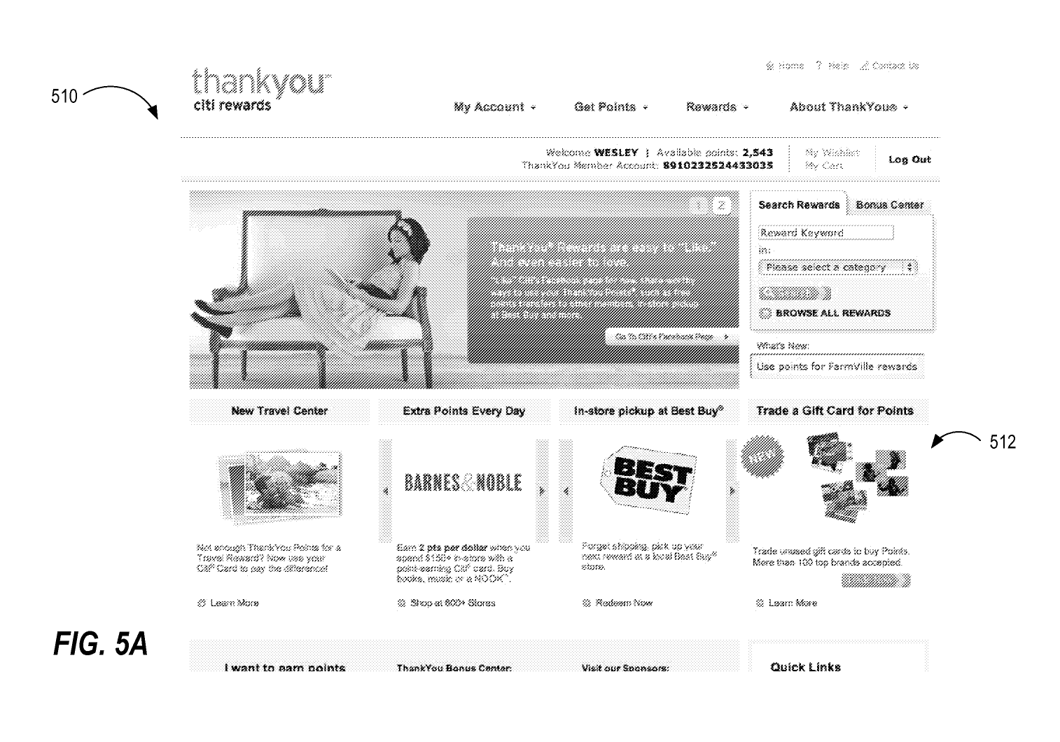

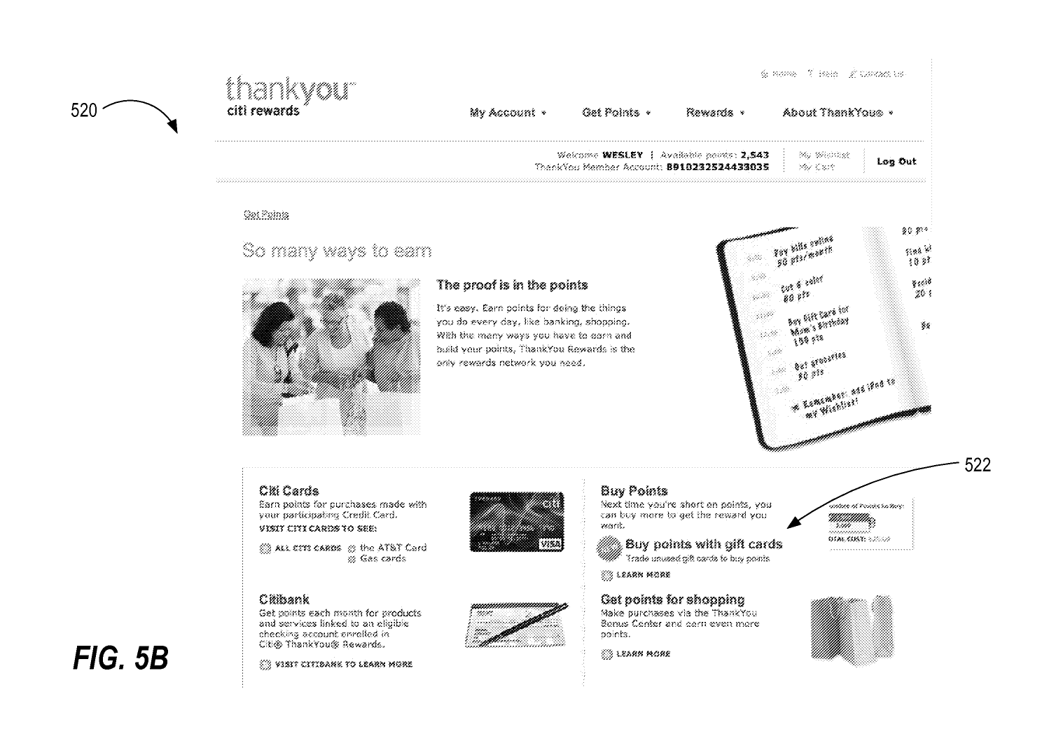

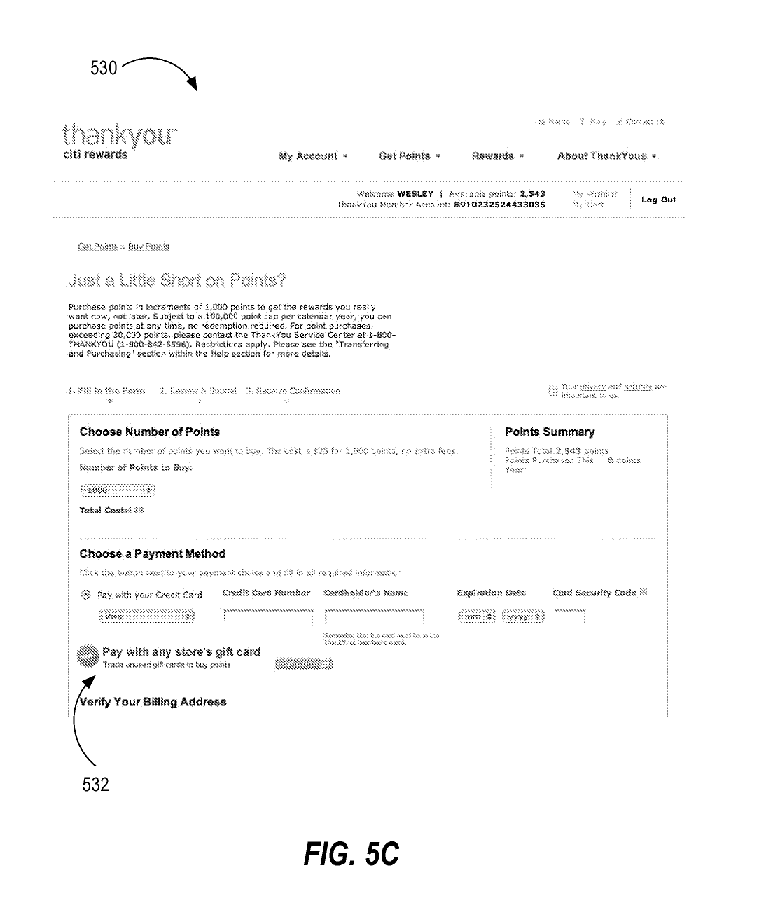

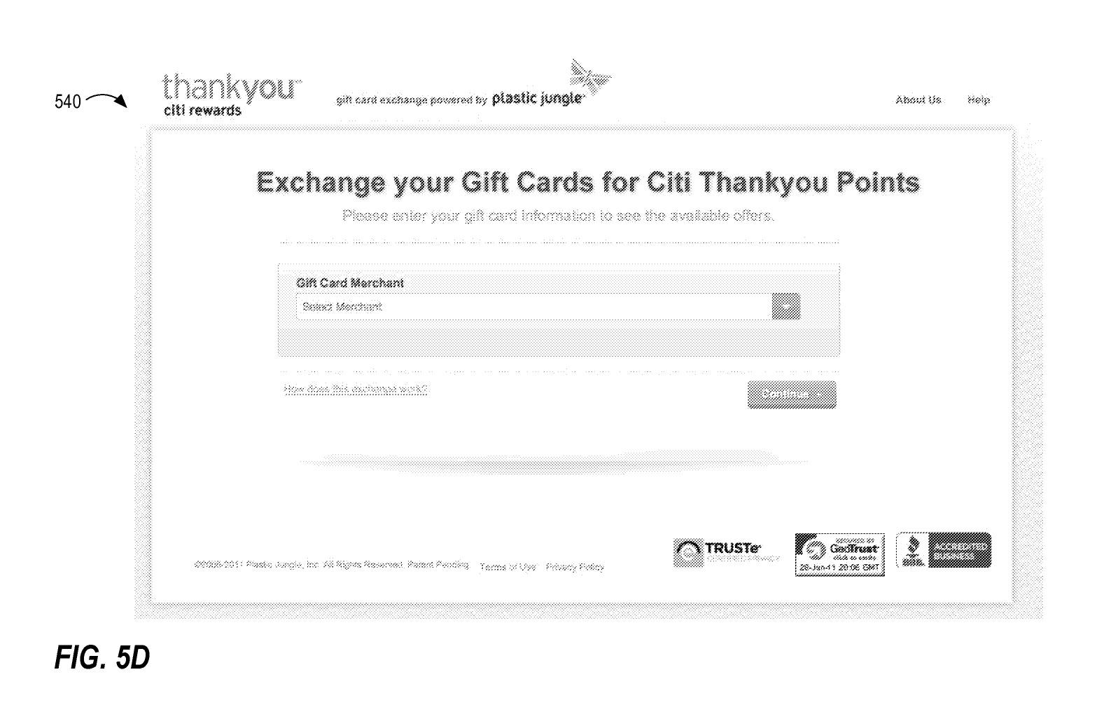

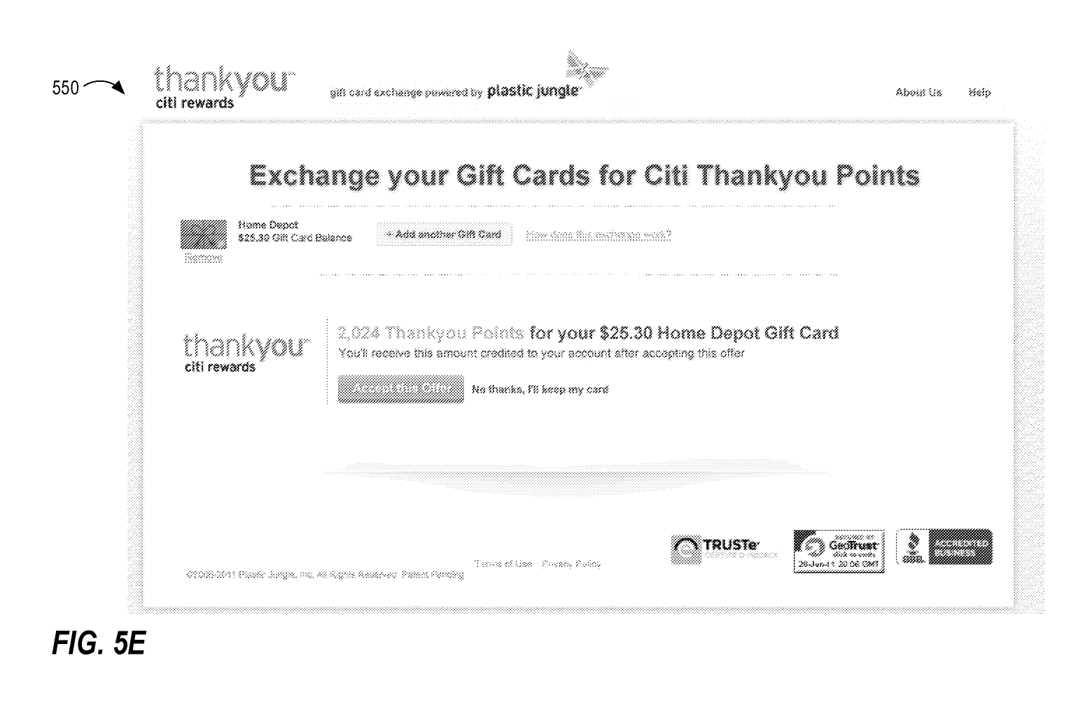

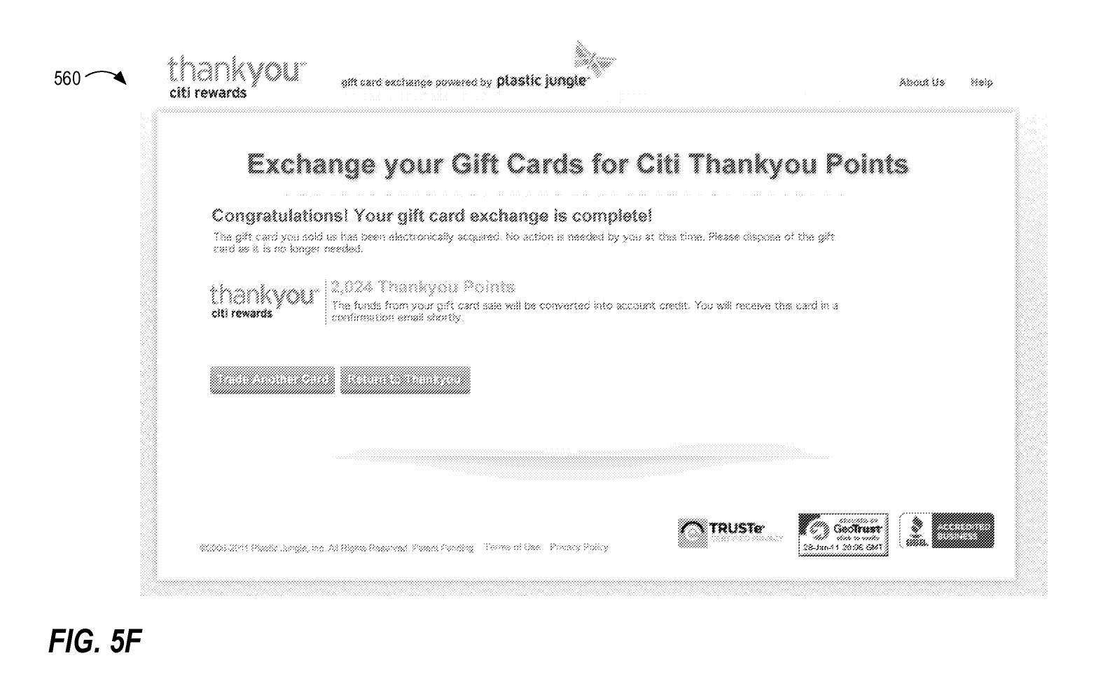

FIGS. 5A-5F are block diagrams that depict example page views that allow a user to trade in a value-ascertainable item for reward points, in an embodiment. Specifically, FIGS. 5A-C are block diagrams that depict, respectively, example page views 510, 520, and 530 that inform a user regarding the possibility of the trade-in. Page views 510-530 represent placement opportunities that invite users to utilize exchange service 120. Page views 510-530 are specifically designed to inform the user about the user's reward points: how the reward points can be obtained and/or how they can be redeemed.

Page views 510-530 may be web pages that are served by a web server maintained by or for a particular merchant and that are rendered by a web browser. Alternatively, page views 510-530 may be generated by a “mobile” application that executes on a mobile device of the user and that communicates, over a network, with a server of the particular merchant.

In this example, page views 510-530 are only displayed after a user has logged in to the user's account (e.g., by providing a username and password) associated with the particular merchant. In another embodiment, one or more of page views 510-530 are “public” page views and are not generated specifically for any particular user.

Each of page views 510-530 includes a portion (512, 522, or 532) that indicates that the user may acquire reward points by trading in a gift card. By selecting the “Trade Now” button in page views 510 or 530, or selecting a hyperlink associated with certain text or graphics in portions 512, 522, or 532 page views 510-530, the user is presented with a new view (e.g., page view 540) that allows the user to enter information about a gift card that the user owns. The series of page views that allow the user to enter gift card information and receive reward points is part of a “conversion flow” that is hosted by exchange service 120. In this example, the conversion flow includes branding of both exchange service 120 and the particular merchant.

FIG. 5C depicts page view 530 that allows a user to purchase more reward points. Specifically, page view 530 includes an option to allow the user to specify a number of points that the user desires to purchase. Page view 530 also includes a payment method portion that allows the user to enter credit card information or to trade in a gift card in exchange for reward points.

FIG. 5D depicts a page view 540 that allows a user to select or specify a specific merchant that issued a gift card that the user owns. Page view 540 may be a popup window that is displayed concurrently with at least a portion of the page view (e.g., 530) that immediately preceded page view 540. The content of page view 540 may be provided entirely by the particular merchant that issues the reward points or may be at least partially provided by exchange service 120, in the case of a conversion flow hosted by exchange service 120. After the user selects or specifies a merchant that issued a gift card that the user owns (and selects the “Continue” button), another page view is displayed that allows the user to enter card information about the gift card, such as an account number and (in some cases) a PIN. In an embodiment, page view 540 allows a user to not only specify a merchant, but also enter account information associated with the user's gift card. The information necessary for exchange service 120 to determine validity and balance of a gift card is referred to as “gift card data.”

Depending on which entity provides page view 540, different communication flows are possible. For example, gift card data submitted by a user may be transmitted from the user's device to exchange service 120. As another example, the gift card data may be first transmitted to a server of the particular merchant (i.e., that provides reward points), which then forwards the gift card data to exchange service 120.

Once exchanger service 120 receives the gift card data and determines that the gift card is valid and has a positive balance, exchange service 120 determines an offer to provide the user in exchange for the gift card. In the example of FIGS. 5A-5F, the offer value is a number of reward points (as opposed to another gift card or cash) that are redeemable at the particular merchant in exchange for the user's gift card. The techniques for determining validity and balance of a trade-in item and determining an offer value for the trade-in item may be the same as the techniques described previously.

FIG. 5E depicts a page view 550 that indicates an example offer of 2,024 Thankyou Points for a user's Home Depot gift card that has a balance of $25.30. As noted previously, the offer amount (i.e., 2,024 Thankyou Points) may vary depending on the issuer of the gift card and market conditions.

Page view 550 also includes a mechanism to accept this offer. In this example, the mechanism is an “Accept this Offer” button. Acceptance of the offer causes page view 560 depicted in FIG. 5F to be displayed.

Page view 560 indicates that the exchange of the gift card for reward points is complete. The user is able to immediately use the reward points (i.e., 2,024 in this example) as if the reward points were accrued in a traditional way (e.g., based on a certain amount of purchases using a credit card issued by the particular merchant). Page view 560 also indicates that a confirmation email will be sent to the user. Page view 560 includes a “Trade Another Card” button to allow the user trade in another gift card and a “Return to Thankyou” button that allows the user to return to a page view that preceded page view 540, such as page view 530.

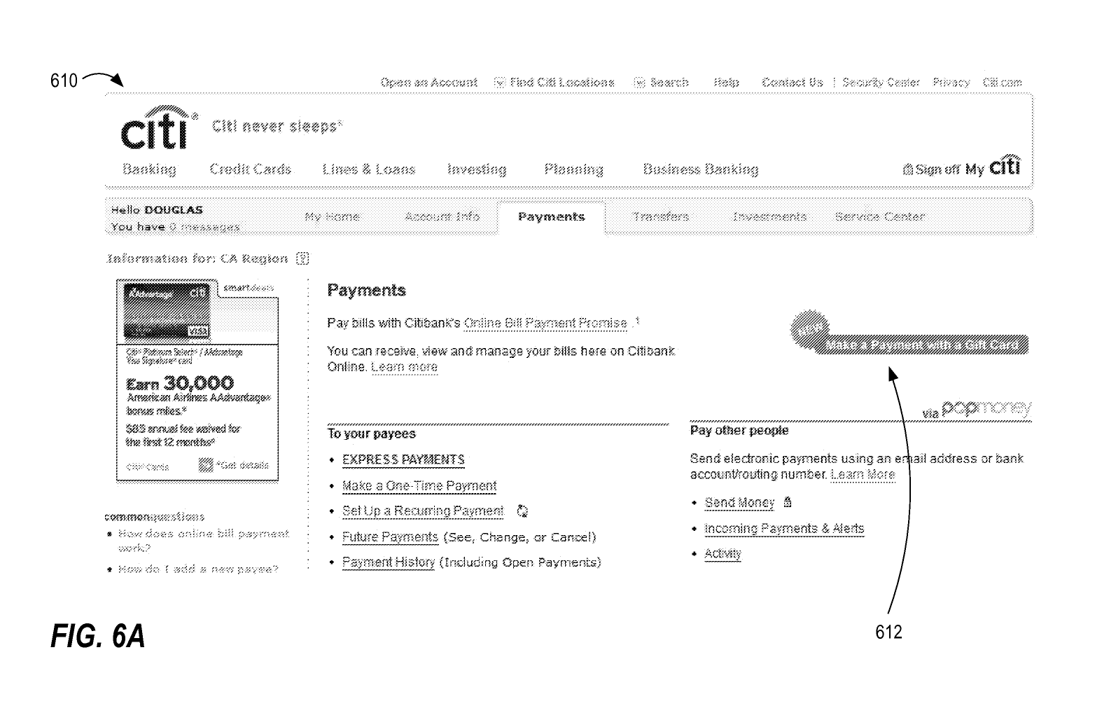

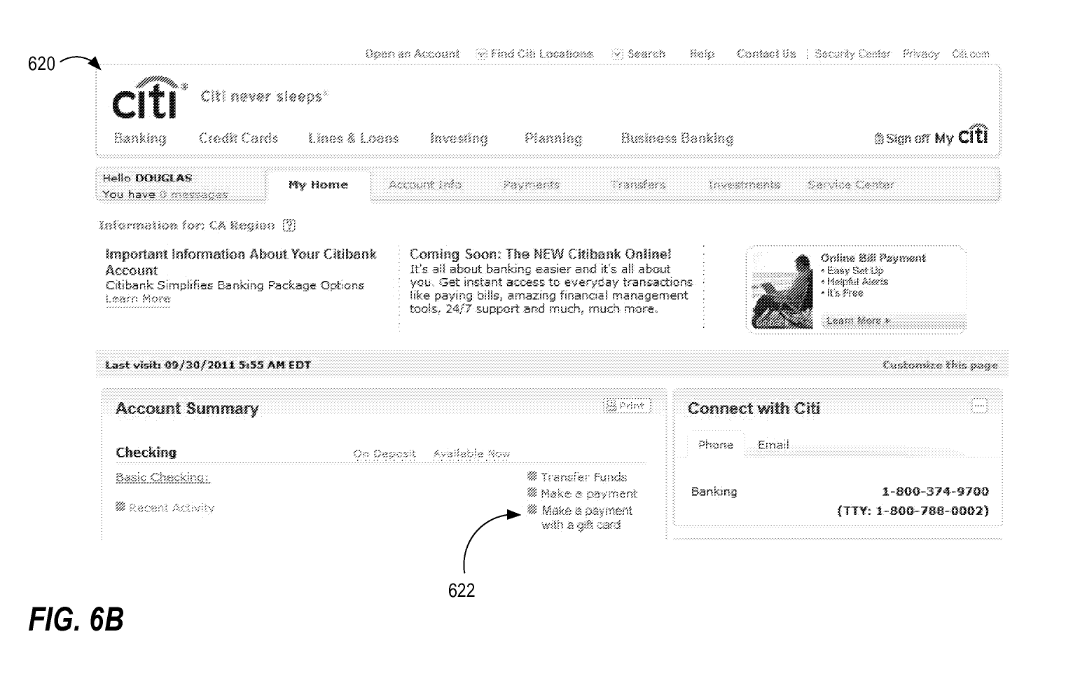

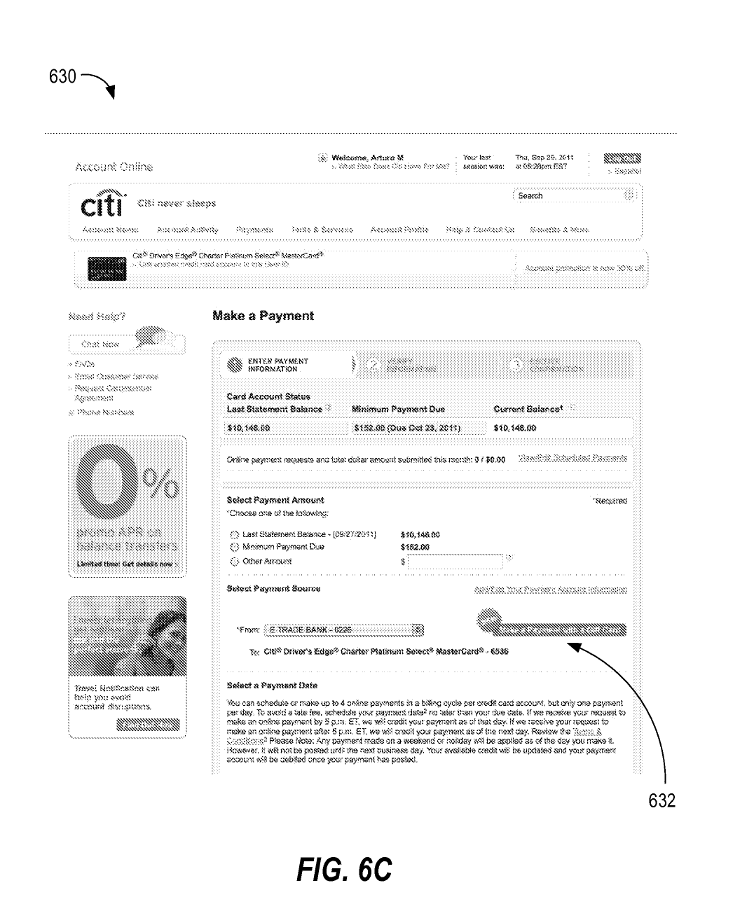

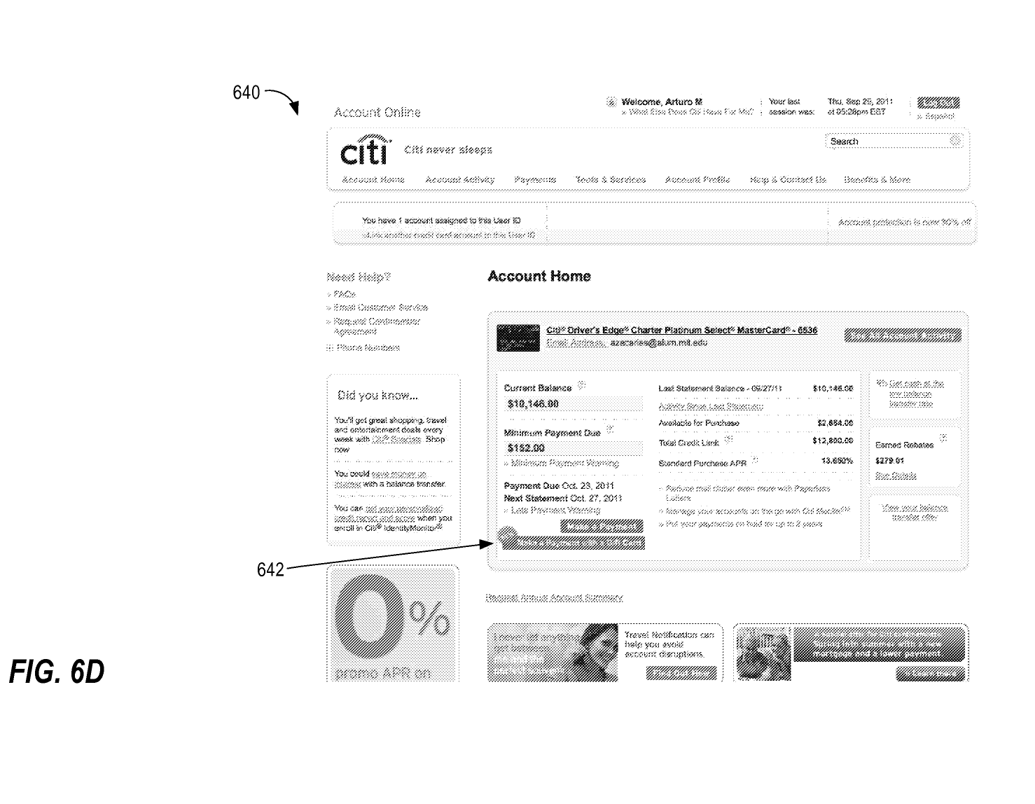

FIGS. 6A-6D are block diagrams that depict example page views 610-640 that allow a user to trade in a value-ascertainable item in order to pay a bill, in an embodiment. In this example, the bill is for a credit card issued for the user. Page views 610-640 represent placement opportunities that invite users to utilize exchange service 120.

Thus, while the offer value in the example of page views 550-560 indicates a number of reward points of a reward program controlled by the particular merchant, the offer value in the following example is denominated in a national currency, such as dollars, euros, or yuan. While the offer value in the example of page views 550-560, when accepted and applied to the user's account, increase a balance of the account, the offer value in the following example, when accepted and applied to the user's account, decreases a balance of the account, a balance that indicates an amount owed, by the user to the party that maintains or controls the account.

Page view 610 includes information about a user's credit card account and allows the user to view different information about the user's account, such as specific account information, investments, obtaining a loan, transferring money, etc. Although this example involves a credit card account, embodiments of the invention are not limited to this type of account. Examples of other types of accounts that may be credited (through exchange service 120) based on a trade-in item include a debit card account, a utilities account, a (car, home, or health) insurance account, and an online games account.

Page view 610 indicates that a “Payments” tab has been selected. Importantly, page view 610 includes a selectable graphic 612 that allows the user to make a payment toward the user's credit card using a gift card owned by the user. Selection of that graphic may “launch” a “conversion flow” hosted by exchange service 120. Such a conversion flow may be the same as or similar to page views 540-560, described previously.

Page view 620 is similar to page view 610 except that page view 620 indicates that a “My Home” tab has been selected, instead of the “Payments” tab. Page view 620 includes a link 622 that, when selected, allows the user to make a payment toward the credit card account using a gift card owned by the user. Selection of link 622 may launch a conversion flow hosted by exchange service 120, which conversion flow may be the same as or similar to page views 540-560.

Page view 630 is a “Payments” page that allows a user to pay off a credit card bill. Page view 640 indicates a balance of the most recent statement, a minimum payment, a date of when the minimum payment is due, and a current balance. Page view 630 also includes a selectable graphic 632 that, when selected, launches a conversion flow, similar to the conversion flow depicted in pages 540-560.

Page view 640 is an “Accounts Home” page that includes information about a user's account, such as a credit limit, APR, and available balance for purchase. Like page view 630, page view 640 includes a selectable graphic 642 that allows the user to make a payment toward the user's credit card using a gift card owned by the user.

### 7.0 Hardware Overview

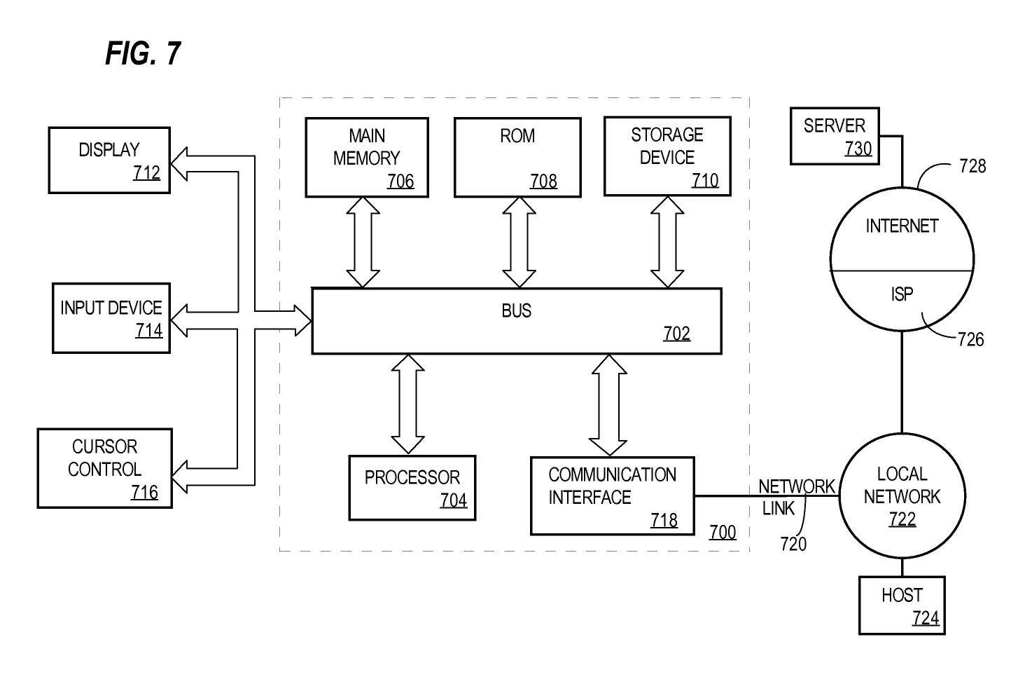

FIG. 7 is a block diagram that depicts a computer system 700 upon which an embodiment of the invention may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions. Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

The invention is related to the use of computer system 700 for implementing the techniques described herein. According to one embodiment of the invention, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 700, various machine-readable media are involved, for example, in providing instructions to processor 704 for execution. Such a medium may take many forms, including but not limited to, non-volatile media, volatile media, and transmission media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution. In this manner, computer system 700 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method comprising:
receiving, from a first device over a network, first item data that indicates a value-ascertainable item;
in response to receiving the first item data, determining an offer value for the value-ascertainable item;
sending, to the first device, the offer value for the value-ascertainable item;
receiving, from the first device, acceptance data that indicates that a user of the first device accepted the offer value;
in response to receiving the acceptance data, storing data that associates the offer value with the user of the first device;
sending, to a particular device of the user, account identification data that identifies an account of a merchant;
wherein the method is performed by one or more computing devices.

2. The method of claim 1, further comprising, in response to receiving the acceptance data, storing association data that associates the user with the account identification data, wherein sending the account identification data comprises sending the account identification data to the particular device.

3. The method of claim 2, wherein:
receiving the first item data and sending the account identification data are performed while the user is in a store of the merchant;
the first device and the particular device is the same device.

4. The method of claim 1, further comprising:
in response to receiving the first item data, determining a market value of the value-ascertainable item;
wherein determining the offer value comprises determining the offer value based on the market value.

5. The method of claim 1, wherein the account identification data includes (a) a bar code that is scannable by a bar code reader or (b) an account identifier.

6. The method of claim 1, wherein:
the value-ascertainable item is a closed-loop stored-value instrument;
the method further comprising sending, over a network, one or more requests to determine a balance of the closed-loop stored-value instrument;
determining the offer value comprises determining the offer value based on the balance.

7. The method of claim 1, further comprising, prior to receiving the first item data:
receiving, from the first device, a request that indicates a user's intention to convert the value-ascertainable item into a second form of payment;
sending, to the first device, selection data that allows the user to enter the first item data.

8. The method of claim 7, wherein the second form of payment is merchant credit that is redeemable at a store of the merchant.

9. The method of claim 7, wherein the request includes merchant data that is used to identify the merchant.

10. The method of claim 9, further comprising, in response to receiving the request:
identifying the merchant;
based on identifying the merchant, selecting, from among a plurality of data flows, a particular data flow that is associated with the merchant;
wherein each data flow of the plurality of data flows is associated with a different merchant of a plurality of merchants.

11. The method of claim 1, further comprising;
receiving, from the particular device of the user, merchant identification data that identifies the merchant.

12. The method of claim 1, further comprising, prior to sending the offer value:
receiving information about the user, the first device, or the value-ascertainable item;
determining a fraud score based on the information;
wherein determining the offer value comprises determining the offer value based on the fraud score.

13. A method performed by a third party, the method comprising:
receiving item data that identifies a value-ascertainable item that is owned by a user and that is provided by a first party that is different than the third party;
based on the item data, determining an offer value that indicates an offer, to the user, for the item data;
in response to receiving input that indicates acceptance of the offer, causing the offer value to be applied to an account that is associated with the user and that is maintained by a second party that is different than the first party and the third party;
wherein the method is performed by one or more computing devices.

14. The method of claim 13, wherein the account is a credit card account or debit card account.

15. The method of claim 13, wherein:
the offer value is an amount denominated in a national currency;
causing the offer value to be applied to the account comprises causing the offer value to reduce a balance of the account.

16. The method of claim 13, wherein:
the offer value is an amount of reward points;
the offer causing the offer value to be applied to the account comprises causing the offer value to increase a balance of the account.

17. The method of claim 13, further comprising, prior to receiving the item data, receiving a request that is associated with the second party, wherein the request is received in response to selection, by the user, of an object that is displayed on a page view provided by the second party.

18. One or more storage media storing instructions which, when executed by one or more processors, cause performance of the method recited in claim 1.

19. One or more storage media storing instructions which, when executed by one or more processors, cause performance of the method recited in claim 3.

20. One or more storage media storing instructions which, when executed by one or more processors, cause performance of the method recited in claim 13.
